(19) United States
(12) Patent Application Publication
(10) Pub. No.: US 2025/0021725 A1
(43) Pub. Date: Jan. 16, 2025

(54) A SYSTEM AND METHOD FOR WEB BASED PERFORMANCE PREDICTIVE MODELLING OF ENGINEERING SYSTEMS

(71) Applicant: WEEDY SOFTWARE PRIVATE LIMITED, BANGALORE (KARNATAKA) (IN)

(72) Inventors: Vineet DRAVID, Bangalore (IN); Prashant Kumar SRIVASTAVA, Bangalore (IN); Prajakta SABNIS, Bangalore (IN)

(73) Assignee: WEEDY SOFTWARE PRIVATE LIMITED, BANGALORE (KARNATAKA) (IN)

(21) Appl. No.: 18/714,568

(22) PCT Filed: Jun. 6, 2023
(86) PCT No.: PCT/IB2023/055828

§ 371 Date: May 30, 2024

(30) Foreign Application Priority Data
Jun. 8, 2022 (IN) 202241032697

(51) Int. Cl. G06F 30/27; G06F 30/12; G06F 119/02

(52) U.S. Cl. CPC G06F 30/27; G06F 30/12; G06F 2119/02

(57) ABSTRACT

The present invention discloses a system and method for web based performance predictive modelling of engineering system. The system provides a user interface for allowing a user to define at least one property and at least one configuration of an engineering system and to select a set of experimental data for predictive modelling. The system includes a computing device coupled in communication with the user interface is configured to receive the property and the configuration of an engineering system and the experimental data for predictive modelling. The computing device process the experimental data for creating a processed data set and also generate operational profiles for the engineering system. The computing device trains a machine learning model using the processed data and synthetic data to generate a trained machine learning model and predicts the performance of the engineering system using the trained machine learning model.

### FIELD OF THE INVENTION

The present invention relates to a system and method for predictive modelling and management of physical system, in particular, it relates to the design of an interface and communication and interplay between experimental data and physics based models.

### BACKGROUND OF THE INVENTION

Computer based models are prevalent as a design tool to optimize product design during the early stages of product development. However, pure physics-based modelling approaches face several limitations when it comes to large parameter spaces to determine parameters necessary for accurate physical analysis. A hybrid approach which uses a combination of physics-based models and experimental data for training and then for performing predictions based on trained models is desirable for more complex environments.

Predicting the performance of an engineering system is a complex process as it involves the various physical, chemical properties of the various materials used as well as the operational profile with engineering system. The performance of the engineering system also depends on various conditions under which the engineering system operates. For predicting the performance of an engineering system the hybrid approach can be used. But the existing solutions for hybrid approach for performance is very complex and not easy for the user to use for various complex engineering system.

Hence, there is a need for a web based solution to predict the performance for the complex engineering system.

### SUMMARY OF THE INVENTION

According to an embodiment, the present invention discloses a system for web based performance predictive modelling. The system includes a user interface for allowing a user to enter user inputs for defining at least one property and at least one configuration of an engineering system and to select at least one set of experimental data for predictive modelling. The system includes a computing device coupled in communication with the user interface. The computing device is configured to receive, from the user, inputs for defining the at least one property and the at least one configuration of an engineering system and the at least one set of experimental data for predictive modelling and processes the at least one set of experimental data for creating a processed data set of the at least one set of experimental data. The computing device also generates, at least one set of operational profile for the engineering system based on the at least one property and the at least one configuration. The computing device trains a machine learning model using the processed data and a set of synthetic data to generate a trained machine learning model, wherein the set of synthetic data is generated by a physics model. The computing device predicts the performance of the engineering system for the at least one set of operational profile by the trained machine learning model.

According to an embodiment, the present invention discloses a method for web based performance predictive modelling. The method includes the steps of providing a user interface for allowing a user to enter user inputs for defining at least one property and at least one configuration of an engineering system; selecting at least one set of experimental data for predictive modelling through the user interface and processing the at least one set of set of experimental data for creating a processed data s of the at least one set of experimental data. The method also includes step of generating at least one set of operational profile for the engineering system based on the at least one property and the at least one configuration and training a machine learning model using the processed data and a set of synthetic data to generate a trained machine learning model, wherein the set of synthetic data is generated by a physics model. The method also includes the step of predicting the performance of the engineering system for the at least one set of operational profile using the trained machine learning model.

### BRIEF DESCRIPTION OF THE DRAWINGS

The foregoing and other features of embodiments of the present invention will become more apparent from the following detailed description of embodiments when read in conjunction with the accompanying drawings. In the drawings, like reference numerals refer to like elements.

FIG. 1 & FIG. 1a illustrates a block diagram of the system for predictive modelling, in accordance to an embodiment of the present invention.

FIG. 2 illustrates the block diagram of method of predictive modelling, in accordance with an embodiment of the invention.

FIG. 3 illustrates the overall flow of the system and method according to an embodiment of the invention.

FIG. 4 illustrates a block diagram of user management, in accordance with an embodiment of the present invention.

FIG. 4a illustrates different attributes for user management, in accordance with an embodiment of the present invention.

FIG. 5 illustrates a flow of the system and method with respect to a user login, in accordance with an embodiment of the present invention.

FIG. 6a illustrates the user interface page through which various users access the Sass based system, in accordance with an embodiment of the present invention.

FIG. 6b illustrates a user interface where the user enters after login in an example embodiment of the present invention.

FIG. 6c illustrates the user interface where the property database is defined in an example embodiment of the present invention.

FIG. 6d illustrates the user interface where user defines the cell chemistry and the cell physical properties in an example embodiment of the present invention.

FIG. 6e illustrates how user may define advance cell properties through the user interface in an example embodiment of the present invention.

FIG. 6f illustrates a user interface showing properties defined by the user in an example embodiment of the present invention.

FIG. 6g illustrates a user interface for defining another property PCM for cell pack in an example embodiment of the present invention.

FIG. 6h illustrates the user interface for processing the data for various applications in an example embodiment of the present invention.

FIG. 6i illustrates an user interface implementation for processing data in an example embodiment of the present invention

FIG. 6j illustrates an example user interface implementation of the data processing for cyclic aging.

FIG. 6k illustrates an example user interface implementation for performance prediction of cell.

FIG. 6l illustrates an example user interface implementation for designing the cell pack.

FIG. 6m and FIG. 6n illustrate example user interface implementations for defining further granularity to the designing of the engineering system.

FIG. 6o illustrates an example user interface implementation for estimating the thermal property.

FIG. 6p illustrates an example user interface implementation showing the results of the thermal property estimation.

FIG. 6q an example user interface implementation thermal runaway extraction from the processed arc data as

FIG. 6r in an example user interface implementation when the system performs the estimation of drive cycle as

FIG. 6s illustrates an example user interface implementation that provides the result of the estimation.

FIG. 6t illustrates an example user interface implementation for thermal management model training and prediction.

FIG. 6u illustrates an example user interface implementation for defining a new training model for thermal management using the HPCC data.

FIG. 6v illustrates an example user interface implementation through which user may specify the condition under which the predictions are made using the trained model

FIG. 6w illustrates an example user interface implementation for showing the performance prediction based on various metrics for thermal propagation.

FIG. 6x illustrates an example user interface implementation for capacity face model training and prediction models.

FIG. 6y illustrates an example user interface implementation for defining a new training model for capacity fade.

FIG. 6z illustrates an example user interface implementation that shows the prediction result of capacity fade with additional drive cycle data

FIG. 6za illustrates an example user interface implementation that provides the prediction result for capacity fade.

FIG. 7 illustrates an exemplary network environment for implementing the system and method for predictive modelling, in accordance with an embodiment of the present invention.

FIG. 8 illustrates the implementation of the method and system according to an embodiment of the present invention.

### DETAILED DESCRIPTION

In the following detailed description, reference is made to the accompanying drawings that form a part hereof, and in which shown by way of illustration specific embodiments that may be practiced. These embodiments are described in sufficient detail to enable a person skilled in the art to practice the invention, and it is to be understood that other embodiments may be utilized and that logical, mechanical, and other changes may be made within the scope of the embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. The singular forms “a,” “an,” and “the” include plural references unless the context clearly dictates otherwise. The following detailed description is, therefore, not be taken as limiting the scope of the invention, but instead the invention is to be defined by the appended claims.

The engineering system is a system consisting of a plurality of complex engineering which interacts and are mutually related.

The operational profile and configuration includes the data necessary for defining the engineering system.

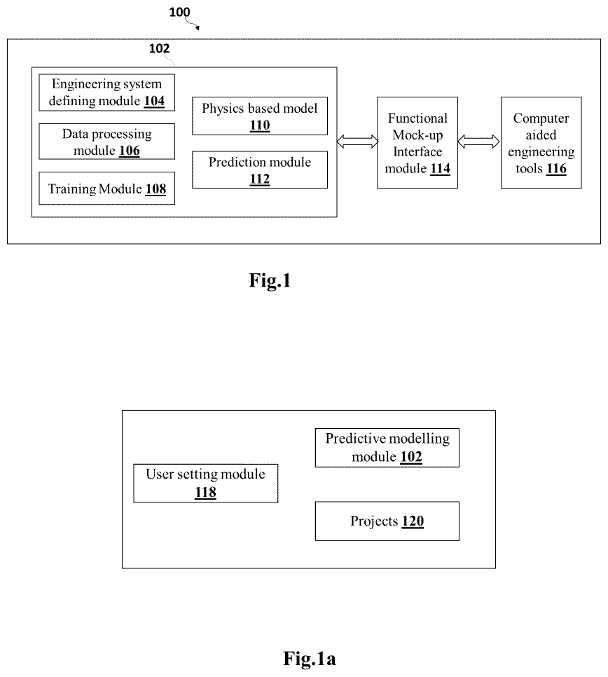

FIG. 1 illustrates a block diagram 100 of the system for predictive modelling, in accordance to an embodiment of the present invention. In particular, the predictive modelling module 102 includes an engineering system defining module 104, a data processing module 106, a training module 108, physics based model 110 and a prediction module 112. The predictive modelling system 100 further includes a functional mockup interface module 114 which provides seamless interaction with other computer aided engineering tools 116.

In an embodiment of the present invention, the engineering system defining module 104 receives data regarding the property and configuration of an engineering system. In an embodiment of the present invention, the user may input the property and configuration through an user interface. The engineering system defining module 104 further determines the operational profile of the engineering system based on the property and configuration received from the user.

In an embodiment of the present invention, the system (100) includes one or more databases for storing a pool of properties and configurations of the engineering system, wherein the pool of properties and configurations comprises system defined and user defined values. Typically, the system (100) includes various databases for storing properties and configuration of the engineering system according to different aspects of the engineering system.

In yet another embodiment of the present invention, the user may select the property and configuration from the options provided by the system through the user interface. In another embodiment the engineering system defining module 104 receives the experimental data from the user. In yet another embodiment of the present invention, the user may upload the experimental data through the user interface. In yet another embodiment of the present invention, the user may select the experimental data from the various experimental data provided by the system through the user interface.

In an embodiment of the present invention, a physics based model 110 generates synthetic data which can complement the set of experimental data for the predictive modelling.

In an embodiment of the present invention, the data processing module 106 processes the data received by the engineering system defining module 104. The data processing module 106 may clean up the experimental data received by the user. In an embodiment of the present invention, the processed data from the data processing module 106 is used by the training module 108. The training module 108 includes a machine learning model. The training module 108 trains the machine learning model using the processed data and a set of synthetic data to generate a trained machine learning model, wherein the set of synthetic data is generated by a physics model 110. In an embodiment of the present invention, the prediction module 112 predicts the performance of the engineering system using the trained machine learning model for the specific operational profile.

According to an embodiment of the present invention, operational profile for the engineering system are generated based on the property and configuration of the engineering system. According to an embodiment of the present invention, the property includes the physical properties of the engineering system. In an embodiment of the present invention, the property includes the chemical properties of the engineering system.

According to an embodiment of the present invention, the system 100 includes the functional mock-up interface module 114 for collaborating with other computer aided engineering tools (CAE) 116. The functional mock-up interface module 114 helps in a seamless interaction of the system as per the present invention to various other engineering tools. In an embodiment of the present invention, the functional mock-up interface module 114 provides input for the predictive modelling module 102, wherein the functional mock-up interface module 114 receives the inputs from other computer aided engineering tools 116. In an embodiment of the present invention, functional mock-up interface module 114 receives the output from the predictive modelling module 102 and transmits the output received to the other computer aided engineering tools 116.

In an embodiment of the present invention, the system for predictive model (100) further includes a user setting module 118 as illustrated in FIG. 1a. The user setting module 118 defines different level of access for users. According to an embodiment of the present invention, the user can create a project 120. The user who creates the project 120 may be identified as a project owner. The project owner based on their level of access may share a project created by one user to other users who are given access by the project owner. Project owner as used herein may be defined as a user who has created the project or who has worked on the project or the user is a supervisor. According to an embodiment of the present invention, many users can work in a collaborative fashion. Thus, the users who are geographically apart also contribute to the project. In an embodiment of the present invention, an organization is one who uses the method as per the invention and the method provides the organization to define different level of users. According to an embodiment of the present invention, the user setting module may create at least one predefined user group. In an embodiment of the present invention, the user setting module may create user groups such that the users in a particular user group may have seamless access across the projects created by the members of the user group.

According to an embodiment of the present invention, the operational profile of the engineering system includes the ambient condition in which the engineering system operates. In yet another embodiment of the present invention, the user may update the operational profile of the engineering system before the system predicts the performance. Typically, the user may make changes to the ambient condition and other such aspects.

According to an embodiment of the present invention, the engineering system is a cell pack. The properties of the engineering system include cell chemistry. In an example embodiment, the cell chemistry helps to define the electrode types. For example, positive electrode is Lithium Nickel Manganese Cobalt Oxide (NMC) and negative electrode is graphite. Further, the physical properties of the cell are also specified including the density, specific heat, thermal conductivity.

According to an embodiment of the present invention, the system is implemented as Software as a Service (SaaS). The SaaS capability provided to the user is to use the provider's applications running on a cloud infrastructure. The applications are accessible from various client devices through a thin client interface such as a web browser (e.g., web-based e-mail). The user does not manage or control the underlying cloud infrastructure including network, servers, operating systems, storage, or even individual application capabilities, with the possible exception of limited user-specific application configuration settings.

According to an embodiment of the present invention, the machine learning model is a physics-informed neural networks (PINNs). PINNs are a type of universal function approximators that can embed the knowledge of any physical laws that govern a given data-set in the learning process, and can be described by partial differential equations. They overcome the low data availability of some biological and engineering systems that makes most state-of-the-art machine learning techniques lack robustness, rendering them ineffective in these scenarios. The prior knowledge of general physical laws acts in the training of neural networks as a regularization agent that limits the space of admissible solutions, increasing the correctness of the function approximation.

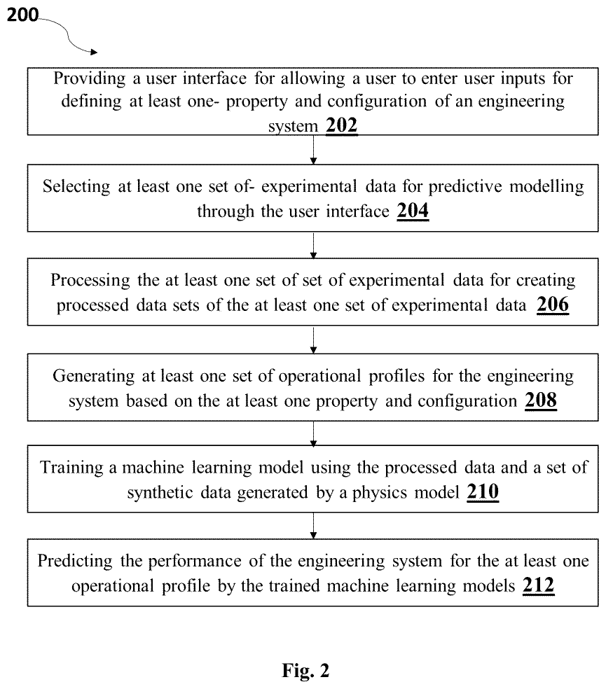

FIG. 2 illustrates the block diagram of method of predictive modelling (200), in accordance with an embodiment of the invention, in accordance with an embodiment of the invention. The method includes the step 202 of providing a user interface for allowing a user to enter user inputs for defining at least one property and at least one configuration of an engineering system and the step 204 of selecting at least one set of experimental data for predictive modelling through the user interface. The method also includes the step 206 of processing the at least one set of set of experimental data for creating a processed data set of the at least one set of experimental data and the step 208 of generating at least one set of operational profile for the engineering system based on the at least one property and the at least one configuration. The method also includes step 210 of training machine learning model using the processed data and a set of synthetic data to generate a trained machine learning model, wherein the set of synthetic data is generated by a physics model. The method further includes the step 212 of predicting the performance of the engineering system for the at least one set of operational profile using the trained machine learning model.

According to an embodiment of the present invention, the step of user selecting the at least one set of experimental data comprises uploading the at least one set of experimental data. Typically, the user selects from a set of experimental data generated while performing the experimental run of the engineering system. In an embodiment of the present invention, the experimental data is acquired using sensors. Typically, one or more sensors are used to acquire the data that are required for the experimental data.

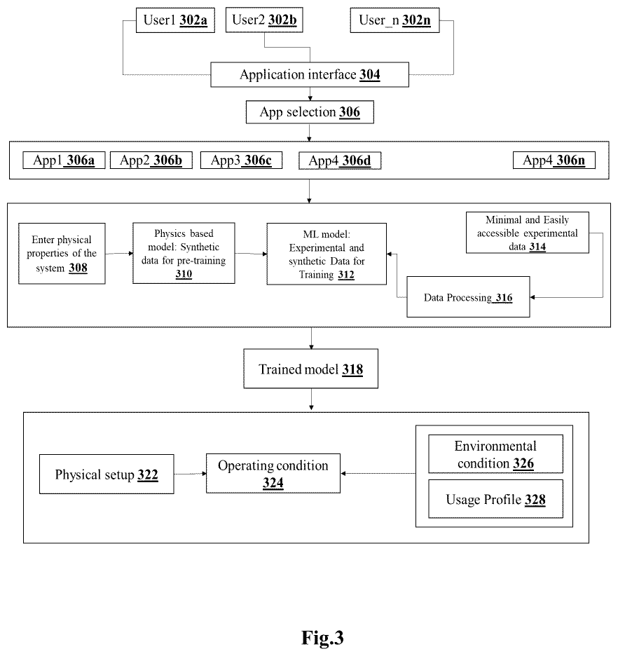

FIG. 3 illustrates the overall flow of the system and method according to an embodiment of the invention. Typically, the system may be used by a plurality of users 302 such as user1 302a, user2 302a up to user_n 302_n. The user 302 may login to the application interface 304 of the system and select an application using the app selection 306 interface. The user may select one of the app from the plurality of applications displayed in the interface. The applications displayed in the interface may be App1 306a, App2 306b, App3 306c, App4 306d and App_n 306n. Once the user 302 selects an application then the user 302 has to provide the various physical properties 308 of an engineering system to a physics model 310 to generate synthetic data for training the machine learning model 312. The user may further provide experimental data 314 and the system process the experimental data 314 at data processing 316. The data processing 316 generates processed data. The machine learning model 312 receives the synthetic data generated by the physics model 310 and the processed data from the data processing 316, further the machine learning model 312 gets trained using the data received and generates a trained model 318. The trained model 318 predicts the performance of the engineering system based on the operational profile. The operational profile includes the data regarding the physical setup 322 of the engineering system, which act as the input for the operating condition 324. The operating condition 324 further depends on the environmental condition 326 and usage profile 328. The performance of the engineering system is predicting using the trained model and the operating condition.

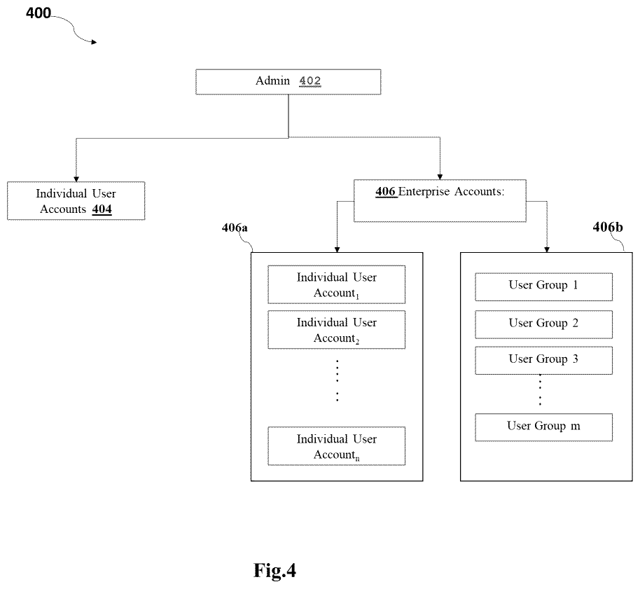

FIG. 4 illustrates a block diagram of user management (400), in accordance with an embodiment of the present invention. There are various users who may use the embodiments according to the present invention, where in the access of each user to the system varies. The user who has administration right i.e. admin 402 may define the access of other users including the individual user account 404 and enterprise user accounts 406. The enterprise account 406 may further define the various super users, access control for various other users such that the enterprise account 406 defines the individual users 406a such as individual user account1, individual user account2, individual user account and further it creates user groups 406b such as user group 1, user group 2, user group 3 and so on. The enterprise account 406 may define the various level of collaboration between different user groups and also regarding data sharing.

FIG. 4a illustrates different attributes for user grouping as well as different level of collaboration and data sharing (400a), in accordance with an embodiment of the present invention. The enterprise account 406 defines different user groups 408 based on various attributes 430 such as project specific 410 attribute, application specific attribute 412, license specific attribute 414, access level specific 416 and so on. The collaboration and data sharing 440 among different users in the user groups 408 may be on different level of data sharing such as data sharing between various users in the same user group or sharing data with different user group i.e. inter and intra-group data sharing 418, data regarding tracking project progress i.e. project progress tracking 420, sharing the space data including both inter and intra i.e. inter and intra space data sharing 422 and so on.

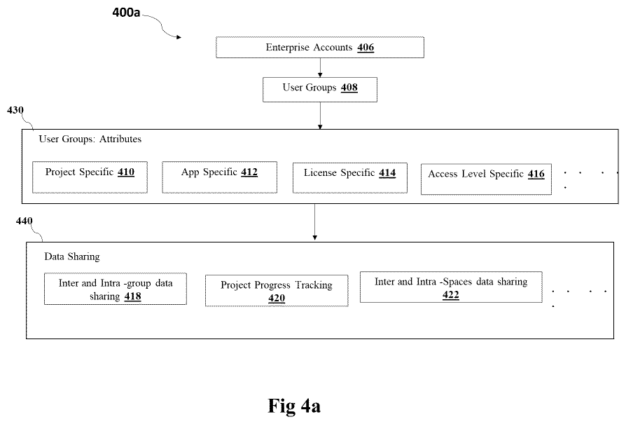

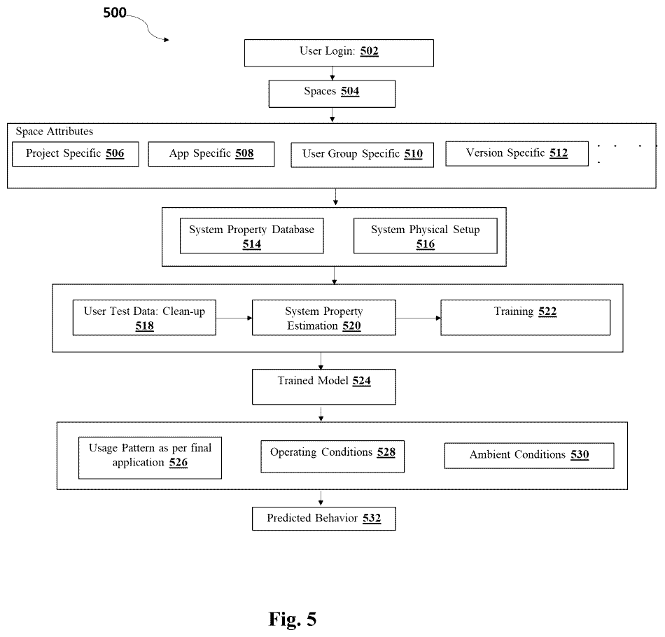

FIG. 5 illustrates a flow of the system (500) with respect to a user login, in accordance with an embodiment of the present invention. Typically, users enter the application through the user login 502. Once the user logs into the system then the user enters a space 504 i.e. project specific folders created by users depending on various attributes such as project specific 506, application specific 508, user group specific 510, version specific 512 and so on. For example, user may create spaces based upon project specification such as two wheeler vs four wheeler project. In another aspect the space may be created based on application specification such that one space may have all thermal models whereas other space may have degradation models. In another scenario, space could be based upon various users group (such as group A space, group B space) or the space may be created based on version specific. For example, the space may be created for the first cut analysis, pilot project, prototype or deployment etc. Once the user creates a space project, the user may define the operational profile of the engineering system by selecting data from the system property database 514 and system physical setup 516. Once the user defines the operational profile for the engineering system then the user may provide the test data and it gets cleaned up in user test data cleanup 518 to generate processed test data and the system then creates synthetic data using the physics model by system property estimation 520, wherein the processed test data and the synthetic data is used for training the model at training 522 to generate a trained model 524. The trained model 524 predicts the performance i.e. predicted behavior 532 of the engineering system using the operational profile as well as the other ambient conditions 530. The operation profile may include usage pattern as per the application 526 and operating condition 528

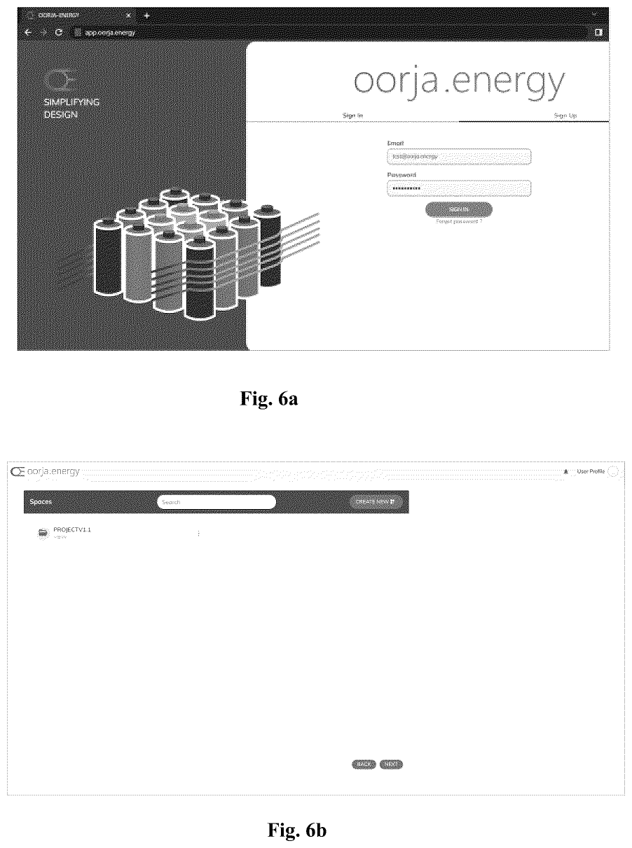

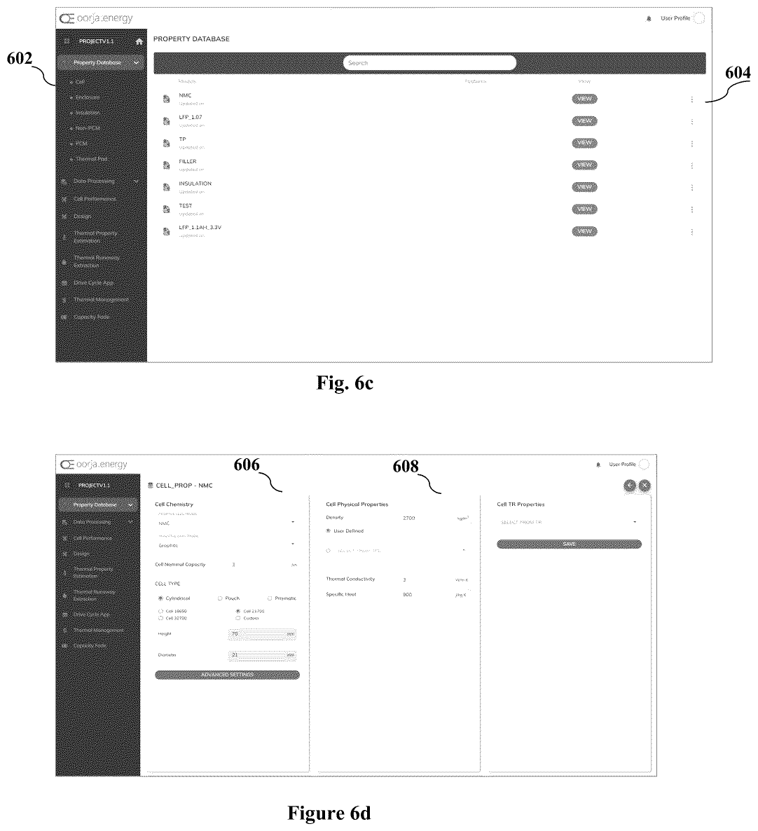

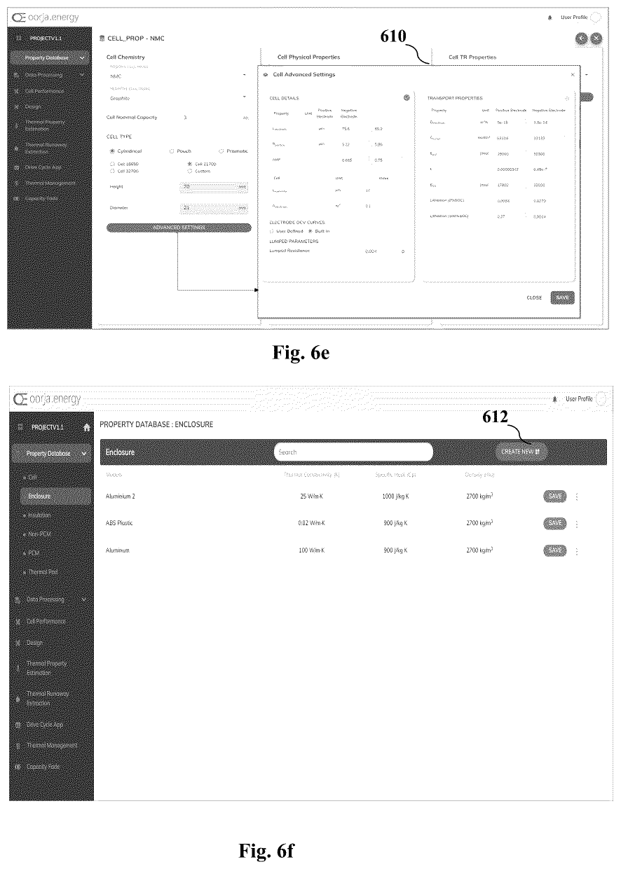

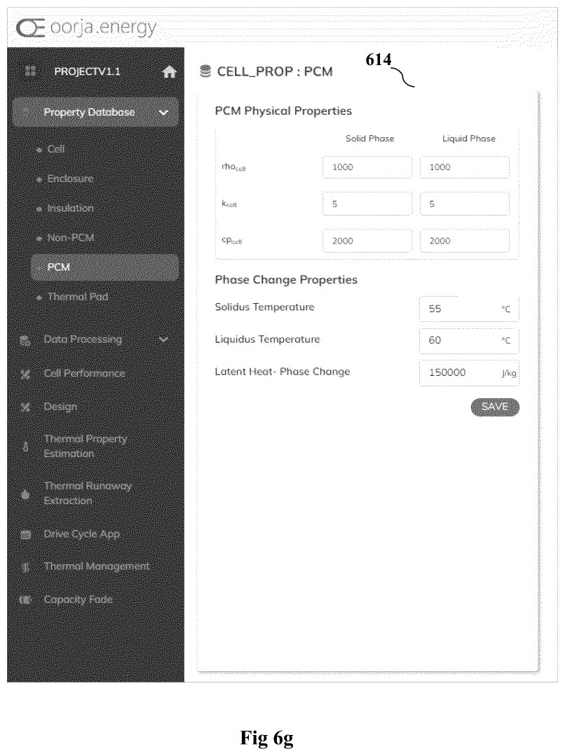

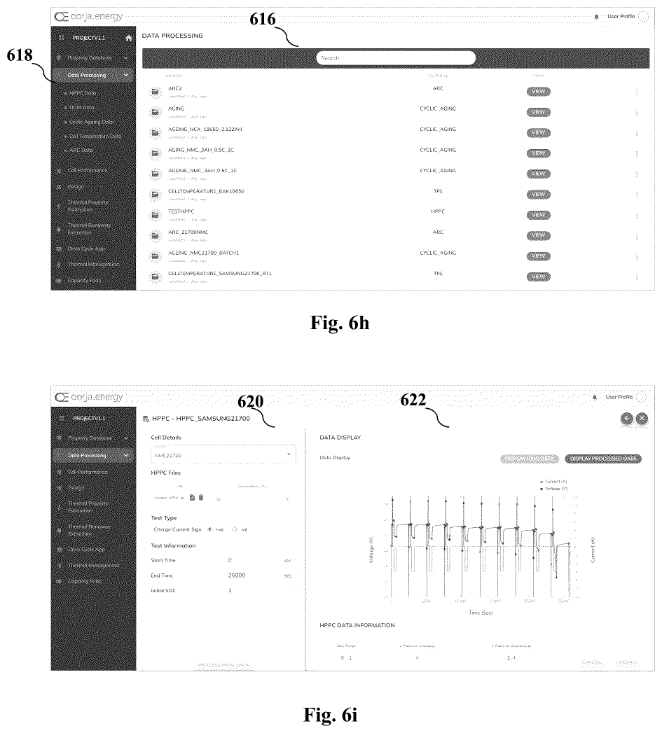

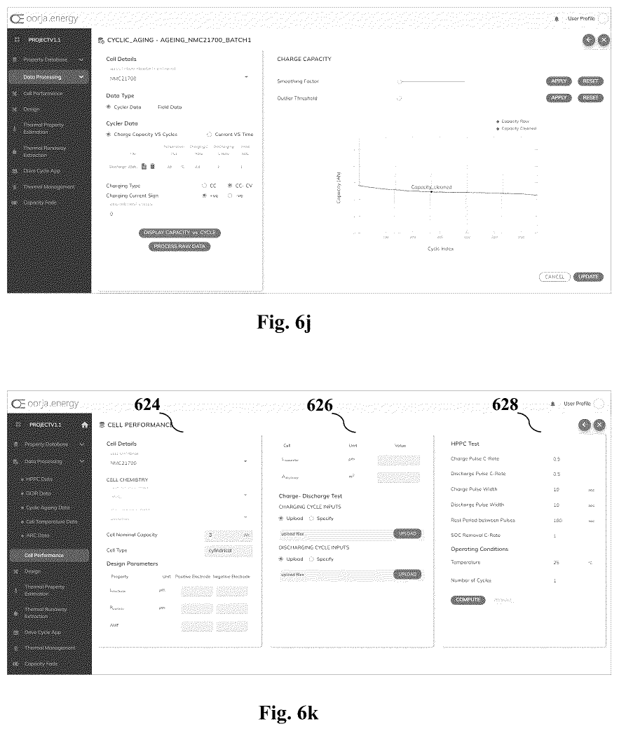

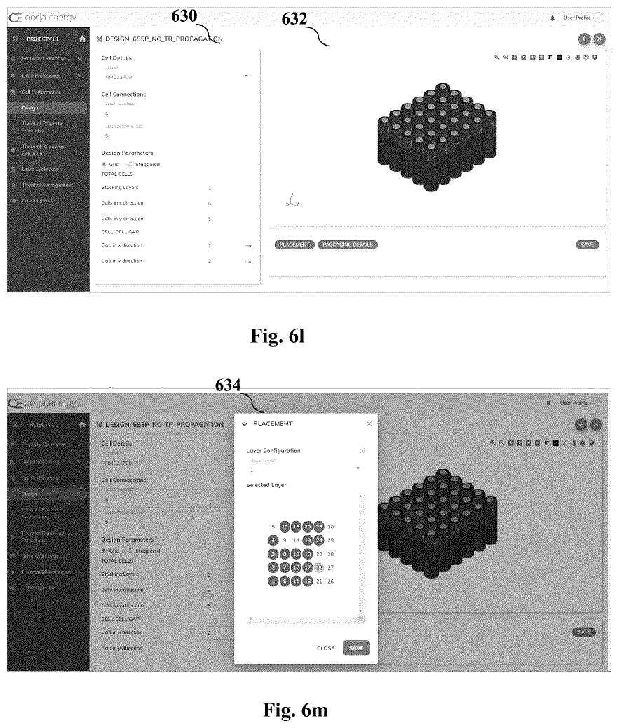

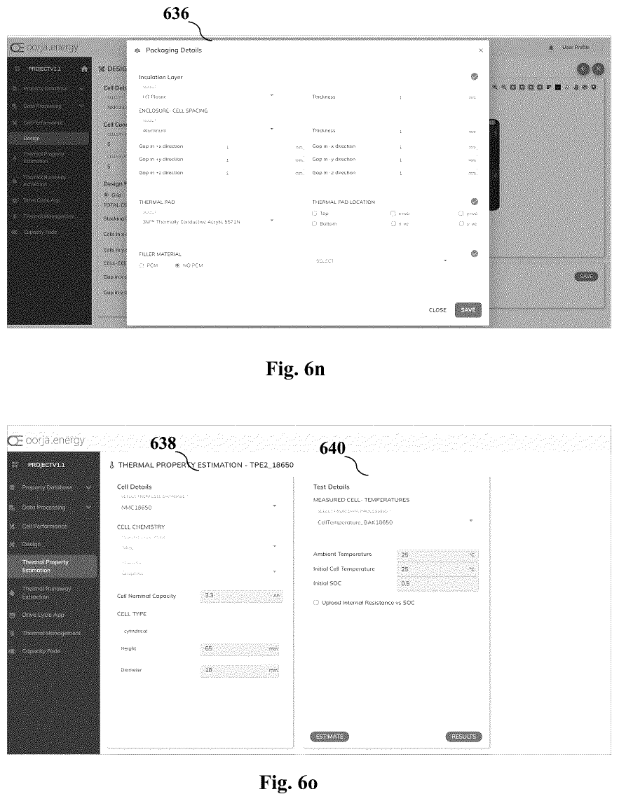

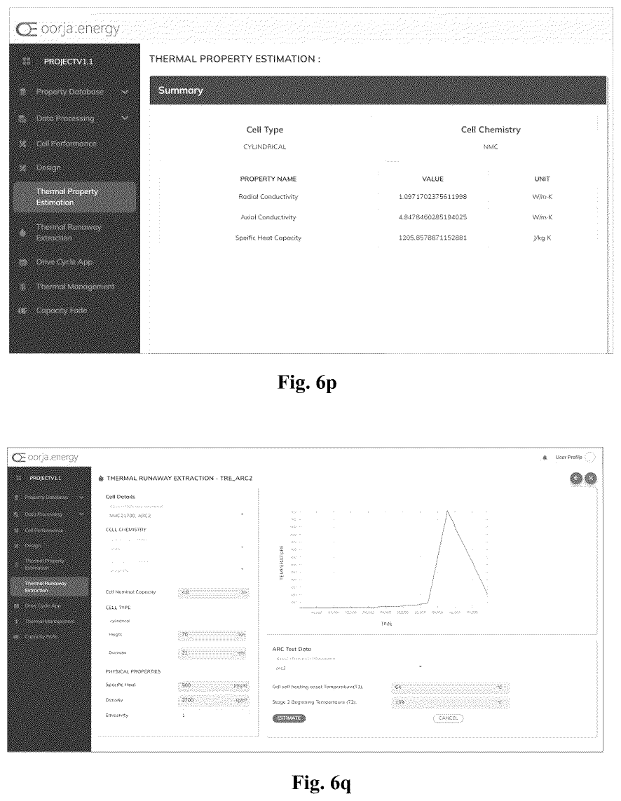

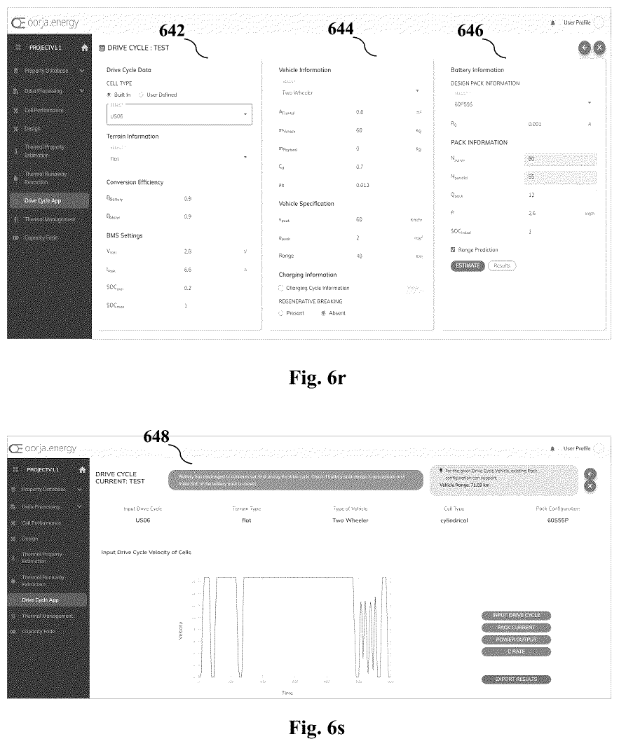

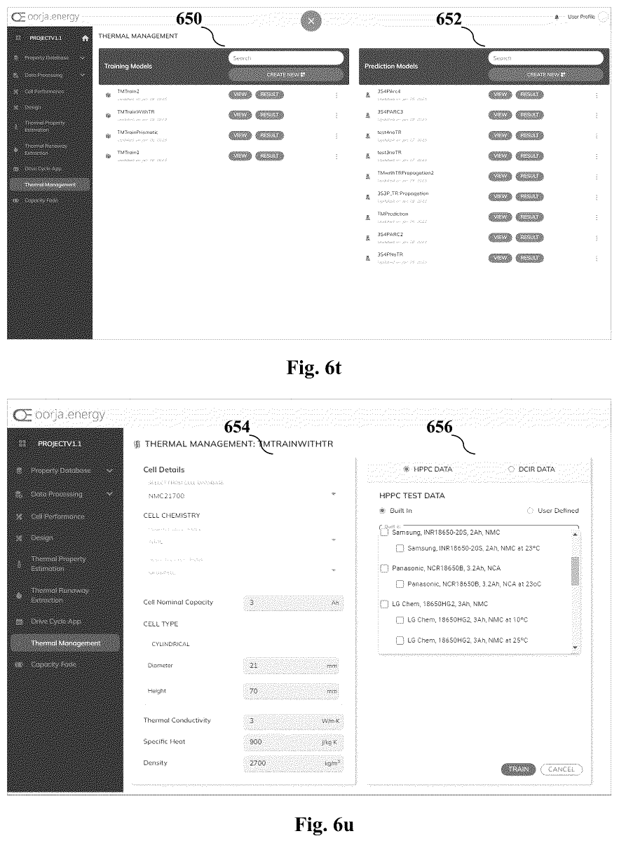

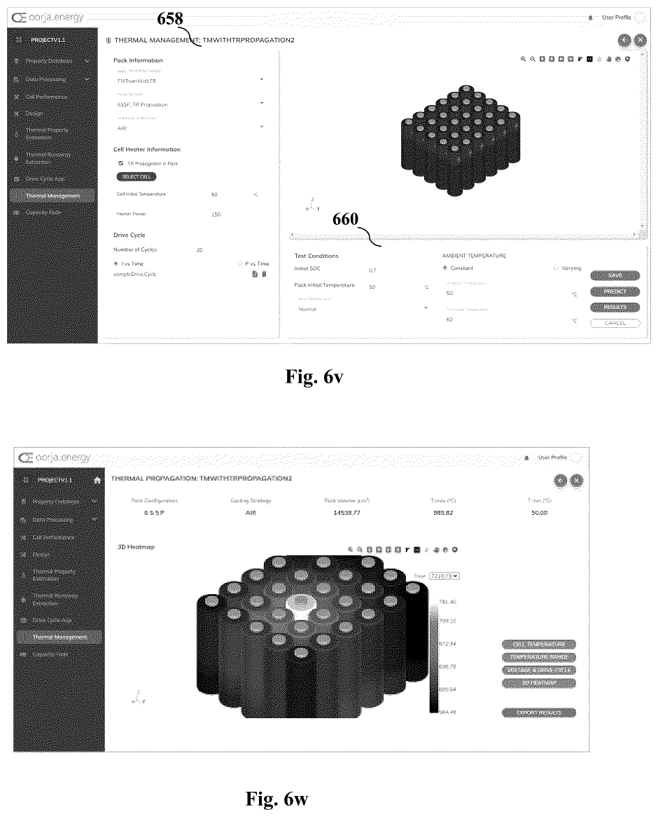

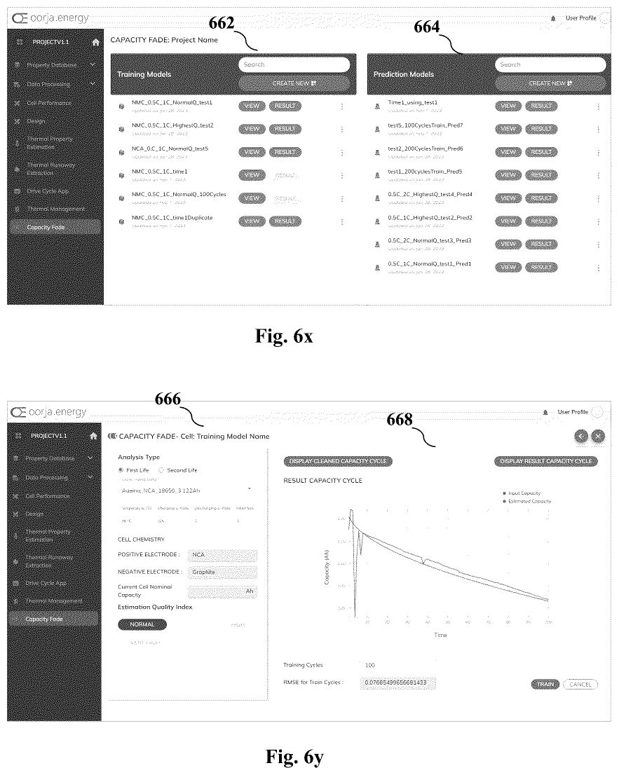

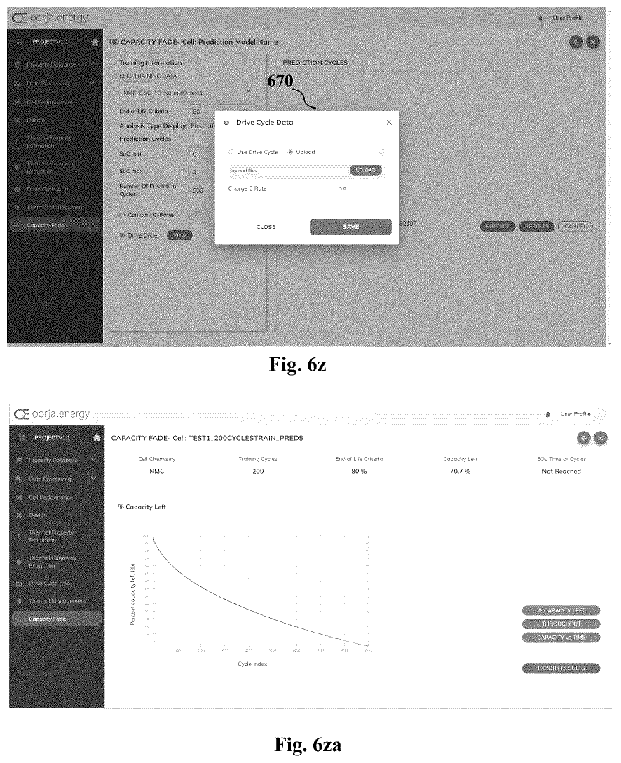

In an example embodiment of the present invention, FIG. 6a illustrates the user interface page through which various users access the Sass based system and method of the present invention. Once the user successfully login the user may enter own space and may create new project or opens an already created project. FIG. 6b illustrates a user interface where the user enters after login in an example embodiment of the present invention through which the user can create a new project. When the user enters the project the user is provided with various options to navigate through the project as per the embodiment of the present invention to define the property and configuration of the engineering system, data processing

User may select various options present in the left pane of the user interface such as property data base. The user may create a property database by selecting the option. FIG. 6c illustrates the user interface where the property database may be defined as per an implementation of the present invention. Left pane 602 of the interface provides the options for defining properties. Right pane 604 illustrates the already created property database for the project. User are provided with options to define the property of an engineering system including the chemical as well as physical properties. FIG. 6d illustrates an example embodiment where user defines the cell chemistry 606 and the cell physical properties 608 through the user interface whereas FIG. 6e illustrates how user may define advance cell properties through the user interface 610.

Further the user may define various other properties of the engineering system, in an example embodiment the few example properties defined by the user are illustrated in FIG. 6f wherein the create new 612 helps the user to define the properties of the enclosure through the user interface as illustrated in FIG. 6g. The FIG. 6g illustrates a user interface 614 for defining a property PCM for cell pack.

In an example embodiment of the present invention, the system provides user interface for processing training data. The data processing may be done for different type of data which are being using the data specific processes. FIG. 6h illustrates the user interface for processing the data for various applications. The right side pane 616 illustrates the already processed data by the user. The left side pane 618 provides options to process various type of data based on their application such as HPPC data, DCR data, cyclic ageing data, cell temperature data, arc data. FIG. 6i illustrates an example user interface implementation for processing data such as HPCC data, the user may upload the HPCC file through 620 and the user may observe the difference between the raw data and processed data in 622 whereas FIG. 6j illustrates an example user interface implementation of the data processing for cyclic aging.

In an example embodiment of the present invention the user is provided with an interface for giving a basic performance prediction based on the input given by the user. FIG. 6k illustrates an example user interface implementation for performance prediction of cell, wherein user may provide cell details through 624, uploading the charging cycle inputs through 626 and HPCC test through 628.

In an embodiment of the present invention, the system provides facility to provide various other configurational aspects of the engineering system in addition to physical and chemical properties of the system. For example, user may design the system. FIG. 6l illustrates an example user interface implementation for designing the cell pack, wherein the user may provide details through 630 and the result may be observed in 632. FIG. 6m provides a user interface 634 for providing layer configuration of the cell and FIG. 6n illustrate example user interface implementations for defining further granularity 636 to the designing of the engineering system regarding packaging details for a cell pack.

In an embodiment of the present invention, the system provides to estimate various parameters required for the operational profile which helps while the prediction module predicts the performance of the engineering system. FIG. 6o illustrates an example user interface implementation for estimating the thermal property wherein user may provide cell details through 638 and test details through 640 whereas FIG. 6p illustrates an example user interface implementation showing the results of the thermal property estimation.

In an example embodiment of the present invention, the system performs the thermal runaway extraction from the processed ARC data as illustrated in FIG. 6q an example user interface implementation.

In another example embodiment of the present invention, the system performs the estimation of drive cycle as in an example user interface implementation FIG. 6r where user may provide drive cycle data through 642, vehicle information through 644 and battery information through 646 and the the estimation results 648 as in an example user interface implementation FIG. 6s.

In an example embodiment of the present invention, the system provides interface for training the model and prediction model. FIG. 6t illustrates an example user interface implementation 650 for thermal management model training and 652 prediction models. FIG. 6u illustrates an example user interface implementation for defining a new training model for thermal management using the HPCC data, where user may provide cell details through 654 and selection of HPCC test data is performed through 656. FIG. 6v illustrates an example user interface implementation through which user may specify the test condition under which the predictions are made using the trained model, where the user may select the training model through 658 and provides test condition through 660. FIG. 6w illustrates an example user interface implementation for showing the performance prediction based on various metrics for thermal propagation. FIG. 6x illustrates an example user interface implementation for capacity face model training and prediction models, where user may see already trained models and may create new models through 662 and may view already created prediction model or may create prediction model through 664. FIG. 6y illustrates an example user interface implementation for defining a new training model for capacity fade, where user may define analysis type through 666 and may view the result through 668. FIG. 6z illustrates an example user interface implementation that shows the prediction result of capacity fade where user may provide additional drive cycle data through 670 whereas FIG. 6za illustrates an example user interface implementation that provides the prediction result for capacity fade.

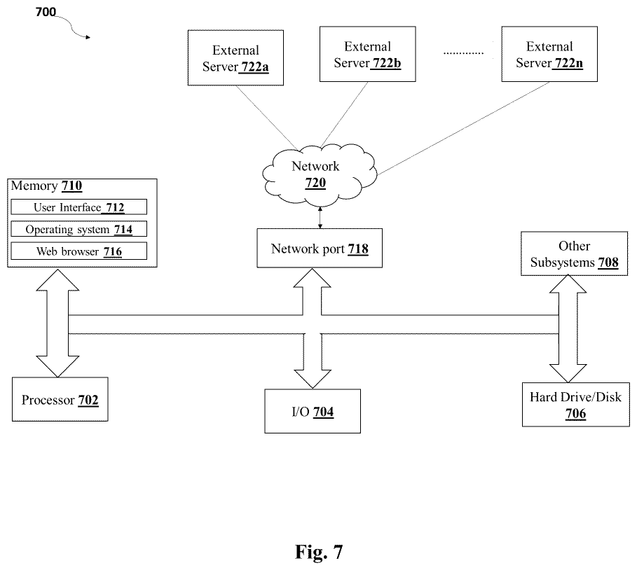

FIG. 7 illustrates an exemplary network environment 700 for implementing the system and method for predictive modelling, in accordance with an embodiment of the present invention. The network environment 700 includes a processor 702, an input/output device 704, a hard drive or hard disk storage 706 and various other subsystems 708, wherein the various subsystems facilitates the functioning of the entire system. The Processor 702 may be disposed in communication with one or more input/output (I/O) devices via I/O interface. The I/O interface may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc. The input/out device 704 may include but is not limited to display, a touchscreen, a mouse and associated controllers for the input/output devices. The network environment 700 also includes a memory 710 of the system, which further includes user interface 712, an operating system 714 and a web browser 716. The network environment 700 further includes the network port 718, which facilitates the connection of the above-mentioned components into the network 720, wherein the network 720 is a communication network. The network port 718 and the network 720, helps in connecting the processor 702 to the various external servers such as 722a, 722b, 722n that contains various data that the system need to perform the hybrid prediction.

In another embodiment, the processor 702 may be disposed in communication with a network 720 via a network port 718. The network port 718 may communicate with the network 720 The network port 718 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The network 720 may include, without limitation, a direct interconnection, local area network (LAN), wide area network (WAN), wireless network (e.g., using Wireless Application Protocol), the Internet, etc.

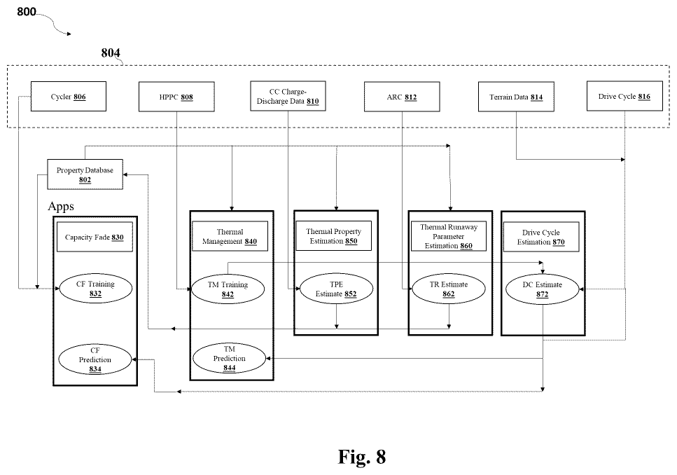

FIG. 8 illustrates the implementation of the system 800 according to an embodiment of the present invention. In an example embodiment, the engineering system defined as per the implementation are for at least one or combination of Li ion cell temperature prediction, Li ion pack thermal management, Li ion pack thermal runaway propagation, Li ion cell degradation, Li ion pack. The system 800 enables the user to perform the data cleanup, property prediction and data management for various predictive modelling. The various engineering system is defined and the various data for training the training module is uploaded from the property database 802 wherein the data processing module 804 processes the uploaded data and the training module comprising various submodules predicts and estimates various values. The data processing module 804 includes various processing modules such as cycler 806 for processing Cyclic Ageing Test, HPPC 808 for processing Hybrid Pulse Power Characterization Test (HPPC) data, constant current (CC) charge discharge data 810 process the data received during constant current charge discharge, ACR 812 for Accelerated Rate calorimetry (Thermal Runaway), terrain data 814 for data regarding various terrains and drive cycle 816 for processing drive cycle data. The data processing module 804 assesses the quality of the uploaded experimental data, and eliminates/levels out noise, spikes and outliers, eliminates inconsistencies in the data, fills in missing values, etc. in the measured data. The data processing module 804 includes various sub modules for performing various data processing. The measured data from various cell test may be cleaned and smoothened using the various sub modules such as cycler 806, HPCC 808, ACR 812, terrain data 814 and drive cycle 816.

The training module (not shown in the figure) may include various sub training models such as capacity fade 830, thermal management 840, thermal property estimation 850, thermal runaway parameter estimation 860 and drive cycle estimation 870.

The property database 802 stores material properties related to cells, pack enclosure materials, thermal pads and thermal insulations. The system allows the user to make multiple projects. Each project may have multiple property databases. Different models under the same project can access properties from different databases, defined under the same project. Data from the property database 802 enables the user to select cathode and anode materials from a dropdown menu. It further enables the user to specify nominal cell capacity, cell type and form factor. Cell's thermal properties and thermal runaway characteristics may be taken from the thermal property estimation (TPE) 850 and thermal runaway parameter estimation (TRE) 860, respectively. When the cell physical properties are known, the user may select from the given list of properties received from Thermal Property Estimate 852. In another instance the user may provide input for specific heat and thermal conductivities. Further the user may select advanced settings to provide the cell's design and electrochemical parameters. The property database 802 may include following databases such as enclosure property database, filler property database and insulation property database that allows to add thermal properties of different types of materials used for battery pack casing, thermal pads and layer insulations respectively.

In one embodiment of the present invention, within a project, the user may select a feature from data processing module 804 to create an instance where experimentally obtained data is uploaded, cleaned and smoothened. A project can have multiple data processing instances, each associated with a unique set of experimental data.

In an embodiment of the present implementation, after the user select the cell information from the property database 802. The user may upload the cell level HPPC data and corresponding temperature in degree centigrade at which the test was carried out. In one embodiment of the present invention, the data file may be in .csv format, which contains columns with column names given as Current, Voltage and Time. In this case, Current may be specified in Amperes, Voltage in Volts and Time in seconds. In an embodiment of the present invention, HPPC experiments with Only Charge or Only Discharge pulses may not be included. In an embodiment of the present invention, the user may need to ensure that rows with comments are also removed from the cycler data file, before the file is uploaded for the cleanup. In yet another embodiment of the present invention, the user may need to specify charging current sign, used in the cycler. In yet another embodiment of the present invention, the user may need to mention the start and end timestamp of the HPPC test need to be mentioned.

The sub-module cycler 806 used to clean the constant charge-discharge cycler data. Here, based on cell information selected by the user from the property database 802, the user or system selects cycler data type to upload charge or discharge capacity vs cycles or current vs time data. In another embodiment of the present invention, the property database 802 specifies corresponding temperature in degree C., at which the test may be carried out. The cycler data is provided in.csv format. The data file contains columns with column names given as capacity, cycle, current and time. In this case capacity is specified in ah, current in amperes and time in seconds. The user has to specify charging current sign, used in the cycler. Further, the user may ensure that rows with comments are removed from the cycler data file, before the file is uploaded for the clean-up. Typically, the user may check the raw data by clicking on the display capacity vs cycle button. Based upon the noise present in the data, initial cycles' data can be discarded. In an embodiment of the present invention the initial cycles' data of about 20-50 cycles of data may be discarded. In one embodiment of the present invention, an increased capacity beyond the nominal cell capacity due anode overhand may be observed. In an another embodiment of the present invention, smoothing factor and outlier threshold may be used for further clean up. In an embodiment of the present invention, the outlier threshold may define how aggressive the algorithm is in removing the outliers while the smoothing factor defines the extent with which the smoothing algorithm removes unwanted spikes from the data. In yet another embodiment of the present invention, the system provides means to save the cleaned data, wherein the cleaned data may be used for further analysis.

The processing module 804 further include the ARC 812 used for cleaning accelerating rate calorimetry test data of the cell. Typically, the user may upload cell level ARC temperature measurement data in .csv format. In another embodiment of the present invention, separate data files for self-heating rate vs temperature and cell temperature vs time may be uploaded. The data files may contain columns with column names given as per the implementation logic for example the column heading may be heating rate, temperature and time. In this case, self-heating rate should be specified in degree C./min, temperature in degree C. and time in minute.

Standard ARC heat-wait-seek (HWS) protocol with the cell in an open configuration may be considered. Specify heat period, seek period and wait period used for the testing, in minutes. Initial and maximum temperatures should be given in degree C. Here, the maximum temperature denotes the maximum heater temperature, applied to the cell, before the cell reaches the onset of thermal runaway. The system further estimates the onset of thermal runaway T1 and stage 2 T2 temperature. The estimated T1 and T2 values may be modified if the override limiting values checkbox is given by the user. ARC 412 further stores the cleaned data which may be used for thermal predictions.

In an embodiment of the present invention, the system includes a thermal runaway parameter estimation 860, wherein the thermal runaway parameter estimation 860 provides the thermal runaway properties based on the user selected or defined cell properties to the property database 802. The system may create multiple thermal runaway estimation (TRE) models for a particular project, wherein the user may select the required runaway estimation model. One project may have multiple TRE models. The TR Estimate 862 validates the estimated properties against the experimental data received from the ARC data 812. The validated data from the TR Estimate 862 are stored in the property database 802.

The system (800) further includes a drive cycle 816 module that may receive the use defined drive cycle data. Typically, the drive cycle 816 receives the data as comma separated value. It can be received in any other format such as XML also. The system also includes a terrain data 814 module, which receives data regarding the various terrains in which testing may be carried out. Typically, when the user provides terrain type as flat, uniform inclination or uneven the system in turn provides terrain elevation information. In an example embodiment, the user may provide the road inclination angle in degrees when the uniform inclination option is selected. When the user provides the type of terrain as uneven, in such cases the user may upload road elevation data. The road elevation data uploaded by the user is processed by the terrain data 814 module.

The drive cycle 870 estimates the drive cycle using DC estimate 872, wherein the DC estimate 872 receives data from the data processing modules terrain data 814 and drive cycle 816.

In an example embodiment of the present invention, for a given thermal management (TM) instance the cell information is retrieved from the property database 802 by the thermal management module 840. The cell information retrieved from the property database 802 includes the chemistry, form factor and thermal properties information for the selected cell. The HPCC 808 provides cell level HPPC Test data (Current and Voltage vs Time) to characterize the cell. TM training 842 trains the TM model. The trained TM model provides the TM prediction 844 for a given drive cycle received from DC estimate 864.

Capacity fade training module 830 may create a training model by providing a name and description. By using physics based degradation models and parameter estimation algorithms, the physical parameter values are extracted from the cycler data. Prediction is done using the training model wherein the training model is a cell level trained parameter model, to predict the capacity fade for a cell or a pack, for a constant charge-discharge cycle or any drive cycle as provided by the data processing sub module the drive cycle 816.

According to an embodiment of the present invention, the web based predictive modelling may be a cloud based system. In yet another embodiment of the present invention, the web based predictive modelling may be a standalone system.

The present invention is tailored towards design engineers. The interface enables engineers to enter available data within a few clicks and without the need to invest time getting trained on complex tools. The present invention enables project sharing among various users, which allows collaboration within and across teams seamlessly. The inherent uncertainties in the physical systems or various engineering systems due to variations in the manufacturing processes and defects can be captured using the experimental data in the hybrid approach whereas physics models that are deterministic cannot account for such variations. Hence the hybrid approach as envisaged in the present invention accounts provides a robust method for design a system with optimized performance. As the present invention caters to various sub systems which contribute to the performance of the complex engineering systems, the present invention enables optimized designing of the complex engineering system in a cost effective manner.

The foregoing description of the preferred embodiment of the present invention has been presented for the purpose of illustration and description. It is not intended to be exhaustive or to limit the invention to the precise form disclosed. Furthermore, all examples recited herein are principally intended expressly to be only for pedagogical purposes to aid the reader in understanding the principles of the present subject matter and are to be construed as being without limitation to such specifically recited examples and conditions. Many modifications and variations are possible in light of the above teachings.

What is claimed is:

1. A system for web based performance predictive modelling, wherein the system comprises:
a user interface for allowing a user to:
enter user inputs for defining at least one property and at least one configuration of an engineering system;
select at least one set of experimental data for predictive modelling;
a computing device coupled in communication with the user interface, said computing device configured to:
receive, from the user, inputs for defining at least one property and the at least one configuration of an engineering system and the at least one set of experimental data for predictive modelling;
process, the at least one set of experimental data for creating a processed data set of the at least one set of experimental data;
generate, at least one set of operational profile for the engineering system based on the at least one property and the at least one configuration;
train, a machine learning model using the processed data and a set of synthetic data to generate a trained machine learning model, wherein the set of synthetic data is generated by a physics model; and
predict, the performance of the engineering system for the at least one set of operational profile by the trained machine learning model.

2. The system as of claim 1, comprises at least one database for storing a pool of properties and configurations of the engineering system, wherein the pool of properties and configurations comprises system defined and user defined values.

3. The system as of claim 1, wherein the user interface enables the user to upload the at least one set of experimental data.

4. The system as of claim 1 comprises a user setting module for defining different level of access for the user and create at least one predefined user group.

5. The system as of claim 1, wherein a Software as a Service (SaaS) is configured to perform the operations of the system.

6. A method for web based performance predictive modelling, wherein the method comprising:
providing a user interface for allowing a user to enter user inputs for defining at least one-property and at least one configuration of an engineering system;
selecting at least one set of experimental data for predictive modelling through the user interface;
processing the at least one set of set of experimental data for creating a processed data of the at least one set of experimental data;
generating at least one set of operational profile for the engineering system based on the at least one property and the at least one configuration;
training a machine learning model using the processed data and a set of synthetic data to generate a trained machine learning model, wherein the set of synthetic data is generated by a physics model; and
predicting the performance of the engineering system for the at least one set of operational profile by the trained machine learning model.

7. The method as of claim 6, wherein the user selects at least one property and configuration of the engineering system from a pool of properties and configurations of the engineering system stored in a database or the user generate their own database.

8. The method as of claim 6, wherein the user selecting the at least one set of experimental data comprises uploading the at least one set of experimental data.

9. The method as of claim 6, wherein a first user collaborates with one or more second user to share at least one project detail, wherein the first user and the one or more second user is selected from a predefined user group.

10. The method as of claim 6, wherein a Software as a Service (SaaS) is configured to perform the operations of the method.
